(19) United States
(12) Patent Application Publication
(10) Pub. No.: US 2026/0329107 A1
(43) Pub. Date: Oct. 22, 2026

(54) CAMERA MODULE AND ELECTRONIC DEVICE

(71) Applicant: LARGAN DIGITAL CO., LTD., Taichung City (TW)

(72) Inventors: Wei Hao CHEN, Taichung City (TW); Yu-Chen LAI, Taichung City (TW)

(21) Appl. No.: 19/630,680

(22) Filed: Mar. 27, 2026

(30) Foreign Application Priority Data
Apr. 17, 2025 (TW) 114114670

(51) Int. Cl. G02B 27/64; G03B 5/00; G03B 30/00; H01F 7/08

(52) U.S. Cl. CPC G02B 27/646; G03B 5/00; G03B 30/00; H01F 7/081; G03B 2205/0023; G03B 2205/0069

(57) ABSTRACT

A camera module includes a base, a first rolling element assembly, a first carrier, a second rolling element assembly, a second carrier, a light path folding element and a first driver. The first rolling element assembly is disposed on the base and includes at least three first rolling elements. The first carrier is connected to the base via the first rolling element assembly. The second rolling element assembly is disposed on the first carrier and includes at least two second rolling elements. The second carrier is connected to the first carrier via the second rolling element assembly. The light path folding element is fixedly disposed on the second carrier. The first driver includes a first driving magnet and a first driving coil. The second carrier includes an attracting element, and the attracting element attracts the first driving magnet.

### RELATED APPLICATIONS

This application claims priority to Taiwan Application Serial Number 114114670, filed Apr. 17, 2025, which is herein incorporated by reference.

### BACKGROUND

### Technical Field

The present disclosure relates to a camera module. More particularly, the present disclosure relates to a camera module applied to the portable electronic device.

### Description of Related Art

In recent years, the portable electronic devices, such as smart electronic device, tablet, etc., are developing rapidly and have applied ubiquitously in the modern life. Accordingly, the camera modules equipped in the portable electronic devices have also flourished. However, as the technology advances, the demands for the image quality in the camera module of the user are increasing. Therefore, to develop a camera module that can improve the image quality has become an important and urgent problem to be solved in the industry.

### SUMMARY

According to one aspect of the present disclosure, a camera module includes a base, a first rolling element assembly, a first carrier, a second rolling element assembly, a second carrier, a light path folding element and a first driver. The first rolling element assembly is disposed on the base and includes at least three first rolling elements, wherein a virtual circle passes a center of each of the at least three first rolling elements, and a first axis passes a center of the virtual circle. The first carrier is connected to the base via the first rolling element assembly, the first rolling element assembly is disposed between the base and the first carrier, and the first carrier rotates by taking the first axis as a rotation center. The second rolling element assembly is disposed on the first carrier and includes at least two second rolling elements, wherein a second axis passes a center of each of the at least two second rolling elements, and the second axis is perpendicular to the first axis. The second carrier is connected to the first carrier via the second rolling element assembly, and the second carrier rotates relative to the first carrier by taking the second axis as a rotation center. The light path folding element is fixedly disposed on the second carrier, wherein the light path folding element makes a light from the first axis being folded to a third axis, and the third axis is perpendicular to the second axis. The first driver includes a first driving magnet and a first driving coil. The first driving magnet is fixedly disposed on the first carrier. The first driving coil is fixedly disposed on the base, wherein the first driver drives the first carrier to rotate by taking the first axis as a rotation center. The second carrier includes an attracting element, and the attracting element attracts the first driving magnet, so that the first carrier and the second carrier are contacted with the at least two second rolling elements simultaneously.

According to another aspect of the present disclosure, an electronic device includes the camera module according the aforementioned aspect, wherein the camera module includes an image lens assembly and an image sensor, and the image sensor is disposed on an image side of the image lens assembly.

According to further another aspect of the present disclosure, a camera module includes a lens group, a light path folding element, a base, a first rolling element assembly, a first carrier, a second rolling element assembly, a second carrier and a first driver. A first axis passes a center of the lens group. The light path folding element is disposed on an image side of the lens group, wherein the light path folding element makes a light from the first axis being folded to a third axis. The first rolling element assembly is disposed on the base and includes at least three first rolling elements, wherein the at least three first rolling elements are respectively equidistant from the first axis. The first carrier is connected to the base via the first rolling element assembly, and the first carrier rotates by taking the first axis as a rotation center. The second rolling element assembly is disposed on the first carrier and includes at least two second rolling elements, wherein a second axis passes a center of each of the at least two second rolling elements, the second axis is perpendicular to the first axis, and the second axis is perpendicular to the third axis. The second carrier is connected to the first carrier via the second rolling element assembly, wherein the second carrier rotates relative to the first carrier by taking the second axis as a rotation center, and the light path folding element is fixedly disposed on the second carrier. The first driver includes a first driving magnet and a first driving coil. The first driving magnet is fixedly disposed on the first carrier. The first driving coil is fixedly disposed on the base, wherein the first driver drives the first carrier to rotate by taking the first axis as a rotation center. The second carrier includes an attracting element, and the attracting element attracts the first driving magnet, so that the first carrier and the second carrier are contacted with the at least two second rolling elements simultaneously.

According to more another aspect of the present disclosure, a camera module includes a lens group, a light path folding element, a base, a first rolling element assembly, a first carrier, a second rolling element assembly, a second carrier and a first driver. A third axis passes a center of the lens group. The light path folding element is disposed on an object side of the lens group, wherein the light path folding element makes a light from a first axis being folded to the third axis. The first rolling element assembly includes at least three first rolling elements, wherein the at least three first rolling elements are respectively equidistant from the first axis. The first carrier is disposed on the base via the first rolling element assembly, and the first carrier rotates by taking the first axis as a rotation center. The second rolling element assembly is disposed on the first carrier and includes at least two second rolling elements, wherein a second axis passes a center of each of the at least two second rolling elements, the second axis is perpendicular to the first axis, and the second axis is perpendicular to the third axis. The second carrier is disposed on the first carrier via the second rolling element assembly, wherein the second carrier rotates relative to the first carrier by taking the second axis as a rotation center, and the light path folding element is fixedly disposed on the second carrier. The first driver includes a first driving magnet and a first driving coil. The first driving magnet is fixedly disposed on the first carrier. The first driving coil is fixedly disposed on the base, wherein the first driving coil drives the first carrier to rotate by taking the first axis as a rotation center. The second carrier includes an attracting element, and the attracting element attracts the first driving magnet, so that the first carrier and the second carrier are contacted with the at least two second rolling elements simultaneously.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional schematic view of a camera module according to the 1st embodiment of the present disclosure.

FIG. 1B is a cross-sectional view of the camera module according to the 1st embodiment of FIG. 1A.

FIG. 1C is an exploded view of the camera module according to the 1st embodiment of FIG. 1A.

FIG. 1D is a schematic view of a first rolling element assembly and a base magnet according to the 1st embodiment of FIG. 1C.

FIG. 1E is a schematic view of a first carrier according to the 1st embodiment of FIG. 1C which rotates by taking a first axis as a rotation center.

FIG. 1F is a schematic view of a second rolling element assembly, the first carrier and a second carrier according to the 1st embodiment of FIG. 1C.

FIG. 1G is a schematic view of the first rolling element assembly, the first carrier and a base according to the 1st embodiment of FIG. 1C.

FIG. 1H is a schematic view of an attracting element according to the 1st embodiment of FIG. 1C.

FIG. 1I is an enlarged schematic view of a first driving magnet, second rolling elements, an attracting element, a first magnetic guiding element, a base magnet and a second magnetic guiding element according to the first example of the 1st embodiment of FIG. 1C.

FIG. 1J is a plane schematic view of a first driving coil, the first driving magnet, the second rolling elements and the attracting element according to the first example of the 1st embodiment of FIG. 1C.

FIG. 1K is an enlarged schematic view of a first carrier, the first rolling element and the base according to the first example of the 1st embodiment of FIG. 1C.

FIG. 1L is an enlarged schematic view of a first driving magnet, second rolling elements, an attracting element, a first magnetic guiding element, a base magnet and a second magnetic guiding element according to the second example of the 1st embodiment of FIG. 1C.

FIG. 1M is a plane schematic view of a first driving coil, a first driving magnet, second rolling elements and an attracting element according to the third example of the 1st embodiment of FIG. 1C.

FIG. 1N is a plane schematic view of a first driving coil, a first driving magnet, second rolling elements and an attracting element according to the fourth example of the 1st embodiment of FIG. 1C.

FIG. 1O is an enlarged schematic view of a first carrier, a first rolling element and a base according to the fifth example of the 1st embodiment of FIG. 1C.

FIG. 2A is a three-dimensional schematic view of a camera module according to the 2nd embodiment of the present disclosure second.

FIG. 2B is a cross-sectional view of the camera module according to the 2nd embodiment of FIG. 2A.

FIG. 2C is an exploded view of the camera module according to the 2nd embodiment of FIG. 2A.

FIG. 2D is a schematic view of a first rolling element assembly and a base magnet according to the 2nd embodiment of FIG. 2C.

FIG. 2E is a schematic view of a first carrier according to the 2nd embodiment of FIG. 2C which rotates by taking a first axis as a rotation center.

FIG. 2F is a schematic view of a second rolling element assembly, the first carrier and a second carrier according to the 2nd embodiment of FIG. 2C.

FIG. 2G is a schematic view of the first rolling element assembly, the first carrier and a base according to the 2nd embodiment of FIG. 2C.

FIG. 2H is a schematic view of an attracting element according to the 2nd embodiment of FIG. 2C.

FIG. 2I is an enlarged schematic view of a first driving magnet, second rolling elements, an attracting element, a first magnetic guiding element, a base magnet and a second magnetic guiding element according to the first example of the 2nd embodiment of FIG. 2C.

FIG. 2J is a plane schematic view of a first driving coil, the first driving magnet, a second driving coil and the attracting element according to the first example of the 2nd embodiment of FIG. 2C.

FIG. 2K is a three-dimensional schematic view of the attracting element according to the first example of the 2nd embodiment of FIG. 2C.

FIG. 2L is a plane schematic view of the attracting element according to the first example of the 2nd embodiment of FIG. 2C.

FIG. 3A is a schematic view of an electronic device according to the 3rd embodiment of the present disclosure.

FIG. 3B is another schematic view of the electronic device according to the 3rd embodiment of FIG. 3A.

FIG. 4 is a schematic view of an electronic device according to the 4th embodiment of the present disclosure.

FIG. 5 is a schematic view of a vehicle instrument of the 5th embodiment of the present disclosure.

### DETAILED DESCRIPTION

The present disclosure provides a camera module including a base, a first rolling element assembly, a first carrier, a second rolling element assembly, a second carrier, a light path folding element and a first driver. The first rolling element assembly is disposed on the base and includes at least three first rolling elements, a virtual circle passes a center of each of the first rolling elements, and a first axis passes a center of the virtual circle. The first carrier is connected to the base via the first rolling element assembly, the first rolling element assembly is disposed between the base and the first carrier, and the first carrier rotates by taking the first axis as a rotation center. The second rolling element assembly is disposed on the first carrier and includes at least two second rolling elements, a second axis passes a center of each of the second rolling elements, and the second axis is perpendicular to the first axis. The second carrier is connected to the first carrier via the second rolling element assembly, and the second carrier rotates relative to the first carrier by taking the second axis as a rotation center. The light path folding element is fixedly disposed on the second carrier, the light path folding element makes a light from the first axis being folded to a third axis, and the third axis is perpendicular to the second axis. The first driver includes a first driving magnet and a first driving coil. The first driving magnet is fixedly disposed on the first carrier. The first driving coil is fixedly disposed on the base, wherein the first driver drives the first carrier to rotate by taking the first axis as a rotation center. The second carrier includes an attracting element, and the attracting element attracts the first driving magnet, so that the first carrier and the second carrier are contacted with the second rolling elements simultaneously.

Therefore, by the arrangement that the first driving magnet is shared by the attracting element and the first driving coil, the number of the elements can be reduced, so that the weight of the camera module can be reduced, and it is favorable for enhancing the driving efficiency. Further, the magnetic field can be guided so as to improve the distribution of magnetic field within a space.

In specific, the attracting element can be disposed on the second carrier, so that the changes in pressure on the second rolling elements during the motion of the carrier can be avoided. The attracting element can be a metal element, e.g., iron that can be attracted by a magnet, and also can be a magnet, but the present disclosure is not limited thereto. Further, the driving coil (such as the first driving coil) of the present disclosure can be fixedly disposed on the circuit board in advance, and then the circuit board is further disposed on the base so as to achieve the fixed relationship between the driving coil and the base.

The first driving magnet can be a multi-pole magnet and includes a first magnetic pole, a second magnetic pole and a third magnetic pole. The first magnetic pole is disposed adjacent to the second magnetic pole and faces the first driving coil. The third magnetic pole is disposed corresponding to the attracting element, and the third magnetic pole is farther away from the first driving coil than the first magnetic pole and the second magnetic pole. Therefore, it is favorable for preventing the attracting element from affecting by the magnetic field of the first driving coil. In specific, the first driving magnet can be configured into a multi-pole magnet during a magnetization process, or the multi-pole magnetic arrangement can also be achieved by bonding a plurality of magnets.

The first driving coil is farther away from the light path folding element than the first driving magnet, and the attracting element is closer to the light path folding element than the first driving magnet. Therefore, the interference of magnetic field between the first driving coil and the attracting element can be reduced so as to enhance the precision of driving and sensing.

The camera module can further include a second driver, the second driver includes a second driving coil, the second driving coil and the attracting element are disposed corresponding to each other, and the second driver drives the second carrier to rotate by taking the second axis as a rotation center. The attracting element can be further used as a driving magnet so as to reduce the use of the magnet. Therefore, the interference of magnetic field can be reduced, and the precision of driving and sensing can be enhanced.

The attracting element can be a multi-pole magnet and includes a fourth magnetic pole, a fifth magnetic pole and a sixth magnetic pole. The fourth magnetic pole is disposed adjacent to the fifth magnetic pole and faces the second driving coil. The sixth magnetic pole and the first driving magnet are disposed corresponding to each other, and the sixth magnetic pole is farther away from the second driving coil than the fourth magnetic pole and the fifth magnetic pole. Therefore, the interference between the two driving directions can be reduced.

The first driving magnet can include a first magnetic pole and a second magnetic pole. The first magnetic pole is disposed adjacent to the second magnetic pole and faces the first driving coil, and a direction from the first magnetic pole to the second magnetic pole is defined as a first magnetization direction. The attracting element is a magnet and has a second magnetization direction, and an attractive force is generated between the attracting element and the first driving magnet. The first magnetization direction is parallel to the second magnetization direction. Therefore, the interference between the magnetic fields can be reduced.

A number of the first rolling elements can be at least four, and the at least four first rolling elements are respectively equidistant from the first axis. Therefore, the stability of the first carrier rotating relative to the first axis can be enhanced.

The base can further include a base magnet, and the first axis passes the base magnet. The first carrier can include a first magnetic guiding element, and the first magnetic guiding element is formed in the first carrier by insert molding. The base magnet attracts the first magnetic guiding element, so that the first carrier and the base are contacted with the first rolling element assembly simultaneously. Therefore, the assembling process of the camera module can be improved. In specific, the first magnetic guiding element can be an iron sheet to attract the first driving magnet.

On a cross section passing one of the first rolling elements and the first axis and being parallel to the first axis, the one of the first rolling elements includes an upper contact point, a lower contact point, an inner contact point and an external contact point. The upper contact point is contacted to the first carrier. The lower contact point is contacted to the base. The inner contact point is closer to the first axis than the upper contact point and the lower contact point. The external contact point is farther away from the first axis than the upper contact point and the lower contact point. The inner contact point and the external contact point are not contacted with the first carrier or the base simultaneously. Therefore, the assembling precision can be enhanced, and it is favorable for preventing the light path folding element and the first carrier from offsetting the rotation center.

A plane is defined by the lower contact point of each of the first rolling elements, wherein the plane is perpendicular to the first axis. Therefore, the first rolling elements can be disposed on the same plane, so that the assembling precision can be further enhanced.

The camera module can further include an image lens assembly, and the image lens assembly can include at least two lens groups. The first axis passes at least one of the lens groups. By optimizing the light incident to the light path folding element in advance, it is favorable for enhancing the image quality, and the generation of the glare can be reduced.

The attracting element can be integrally formed in the second carrier by insert molding. Therefore, the errors generated during the assembling process can be reduced, and the attracting force can be further stabilized.

The first axis, the second axis and the third axis are perpendicular to each other. Therefore, it is favorable for enhancing the functionality of the light path folding element to drive the optical image stabilization (OIS).

The light path folding element can include a reflecting surface, and the reflecting surface is connected to the first axis and the third axis. The first axis and the second axis intersect on the reflecting surface. Therefore, it is favorable for preventing the optical axis from offsetting during the driving process, and thus the image quality can be enhanced.

The second rolling elements can be disposed between the attracting element and the first driving magnet. Therefore, it is favorable for preventing the second carrier from deforming due to the force applied thereon.

The second carrier can further include an assembling block, the assembling block protrudes from the second axis along a direction away from the light path folding element, and the attracting element is disposed on the assembling block. The first carrier can include an accommodating structure for accommodating the assembling block, and the second rolling element assembly is disposed between the assembling block and the accommodating structure. Therefore, the assembling process of the camera module can be improved.

The first driver is symmetrically disposed on an opposite side of the light path folding element on the second axis. The attracting element is symmetrically disposed on the opposite side of the light path folding element on the second axis, and the attracting element is disposed corresponding to the first driving magnet of the first driver. By the symmetrical arrangement of the driving magnet and the attracting element, it is favorable for avoiding the uneven magnetic attraction force, so that the maintaining effects of the carrier can be further enhanced.

The present disclosure provides a camera module including a lens group, a light path folding element, a base, a first rolling element assembly, a first carrier, a second rolling element assembly, a second carrier and a first driver. A first axis passes a center of the lens group. The light path folding element is disposed on an image side of the lens group, and the light path folding element makes a light from the first axis being folded to a third axis. The first rolling element assembly is disposed on the base and includes at least three first rolling elements, and the first rolling elements are respectively equidistant from the first axis. The first carrier is connected to the base via the first rolling element assembly, and the first carrier rotates by taking the first axis as a rotation center. The second rolling element assembly is disposed on the first carrier and includes at least two second rolling elements, a second axis passes a center of each of the second rolling elements, the second axis is perpendicular to the first axis, and the second axis is perpendicular to the third axis. The second carrier is connected to the first carrier via the second rolling element assembly, wherein the second carrier rotates relative to the first carrier by taking the second axis as a rotation center, and the light path folding element is fixedly disposed on the second carrier. The first driver includes a first driving magnet and a first driving coil. The first driving magnet is fixedly disposed on the first carrier. The first driving coil is fixedly disposed on the base, and the first driver drives the first carrier to rotate by taking the first axis as a rotation center. The second carrier includes an attracting element, wherein the attracting element attracts the first driving magnet, so that the first carrier and the second carrier are contacted with the second rolling elements simultaneously.

The present disclosure provides a camera module including a lens group, a light path folding element, a base, a first rolling element assembly, a first carrier, a second rolling element assembly, a second carrier and a first driver. A third axis passes a center of the lens group. The light path folding element is disposed on an object side of the lens group, and the light path folding element makes a light from a first axis being folded to the third axis. The first rolling element assembly includes at least three first rolling elements, and the first rolling elements are respectively equidistant from the first axis. The first carrier is connected to the base via the first rolling element assembly, and the first carrier rotates by taking the first axis as a rotation center. The second rolling element assembly is disposed on the first carrier and includes at least two second rolling elements. A second axis passes a center of each of the second rolling elements, the second axis is perpendicular to the first axis, and the second axis is perpendicular to the third axis. The second carrier is connected to the first carrier via the second rolling element assembly, wherein the second carrier rotates relative to the first carrier by taking the second axis as a rotation center, and the light path folding element is fixedly disposed on the second carrier. The first driver includes a first driving magnet and a first driving coil. The first driving magnet is fixedly disposed on the first carrier. The first driving coil is fixedly disposed on the base, and the first driver drives the first carrier to rotate by taking the first axis as a rotation center. The second carrier includes an attracting element, and the attracting element attracts the first driving magnet, so that the first carrier and the second carrier are contacted with the second rolling elements simultaneously.

The present disclosure provides an electronic device including the camera module according to the aforementioned aspect. The camera module includes an image lens assembly and an image sensor, wherein the image sensor is disposed on an image side of the image lens assembly.

### 1st Embodiment

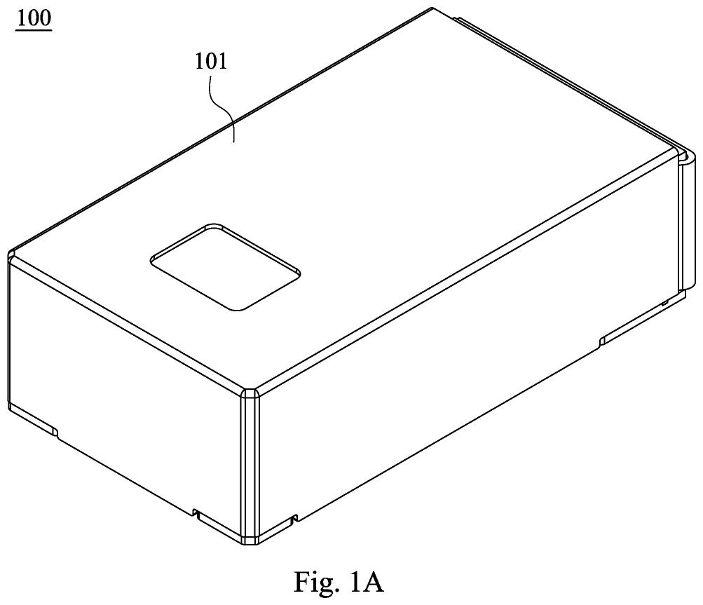

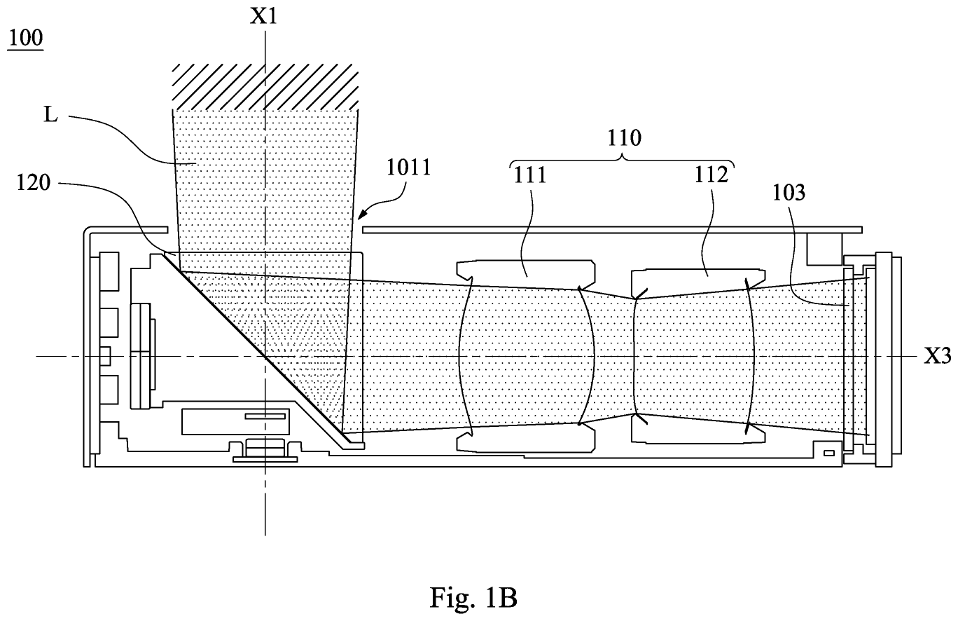

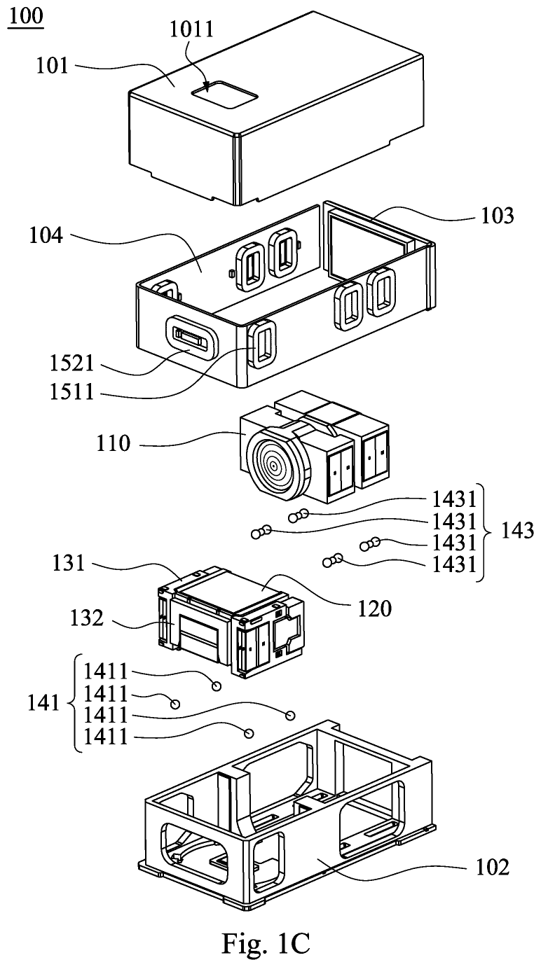

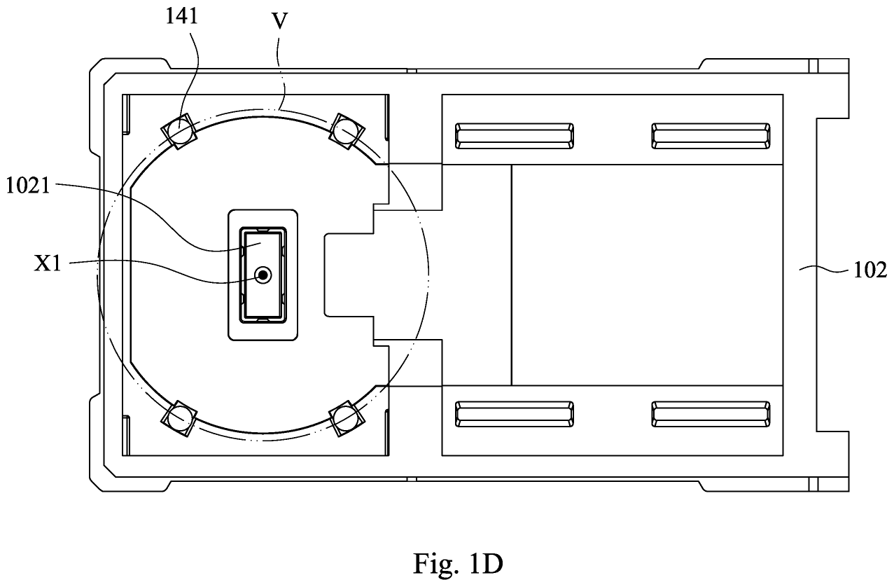

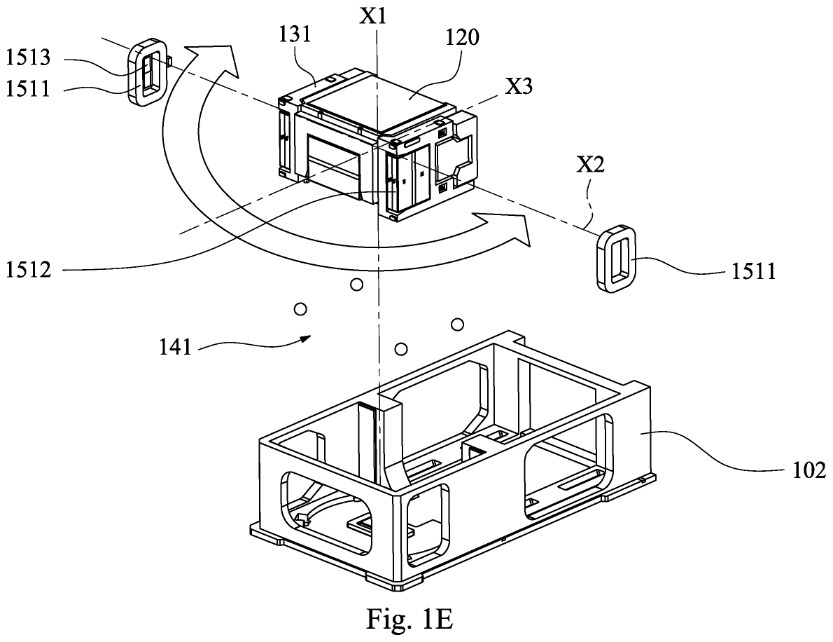

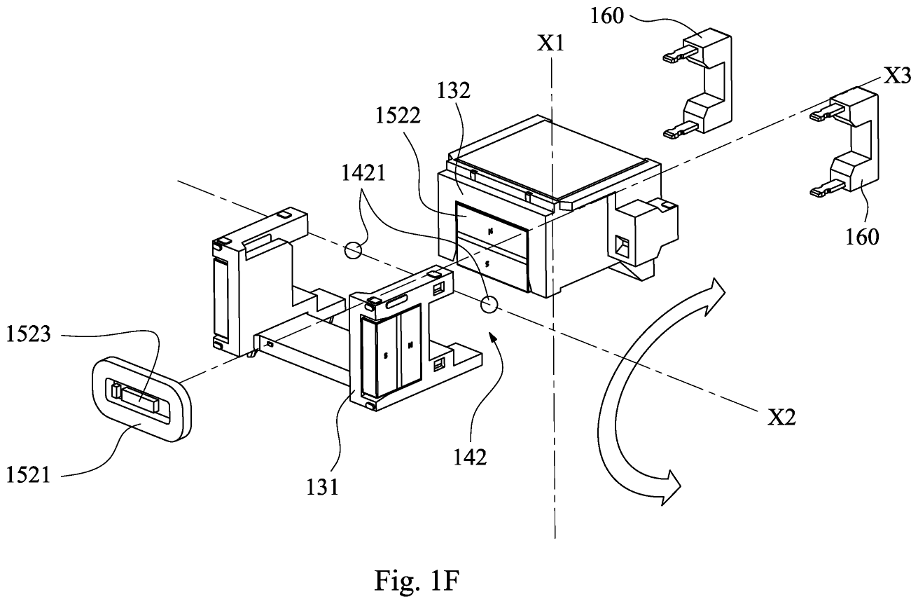

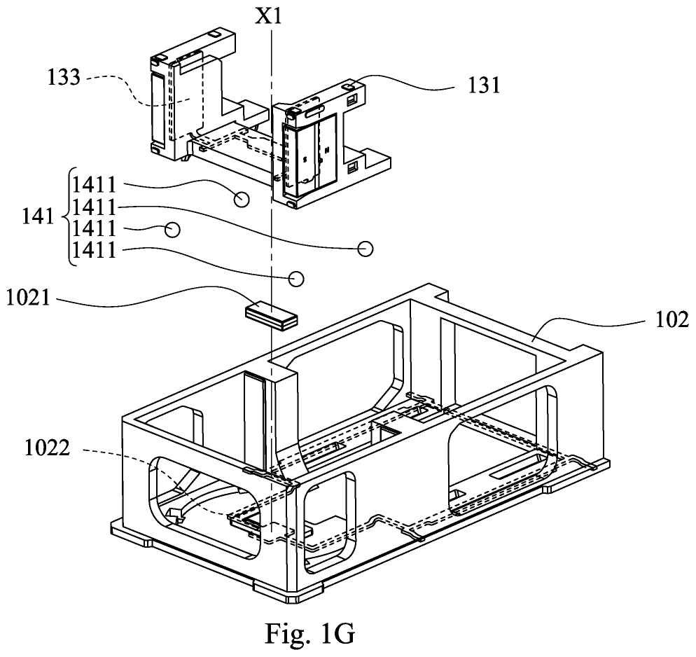

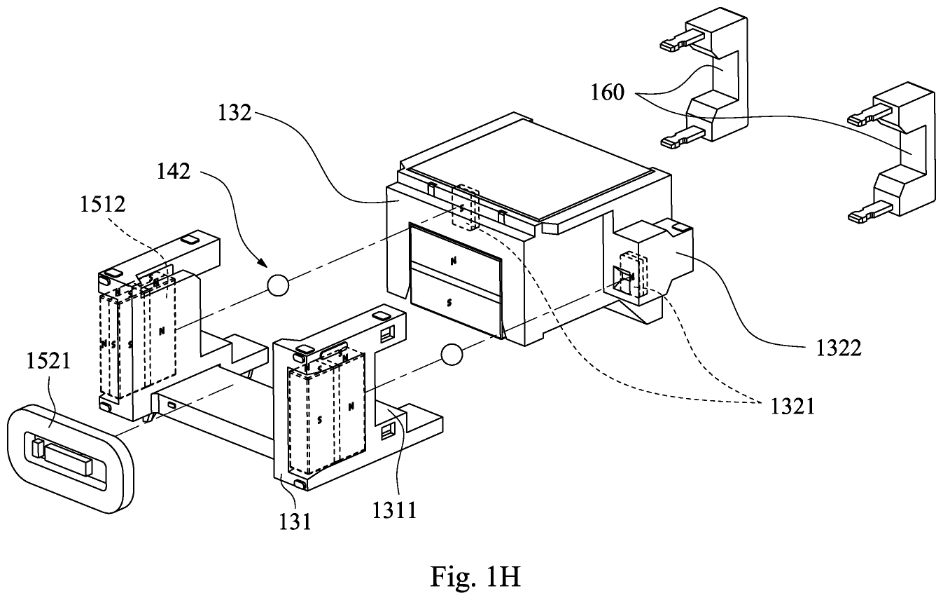

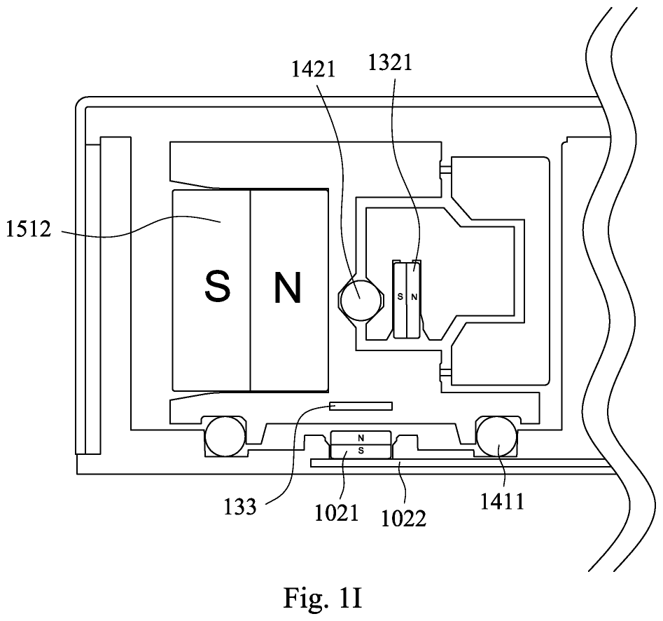

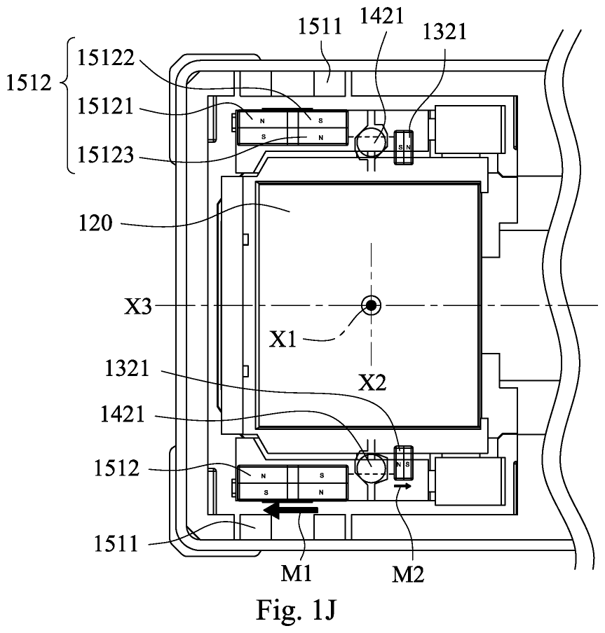

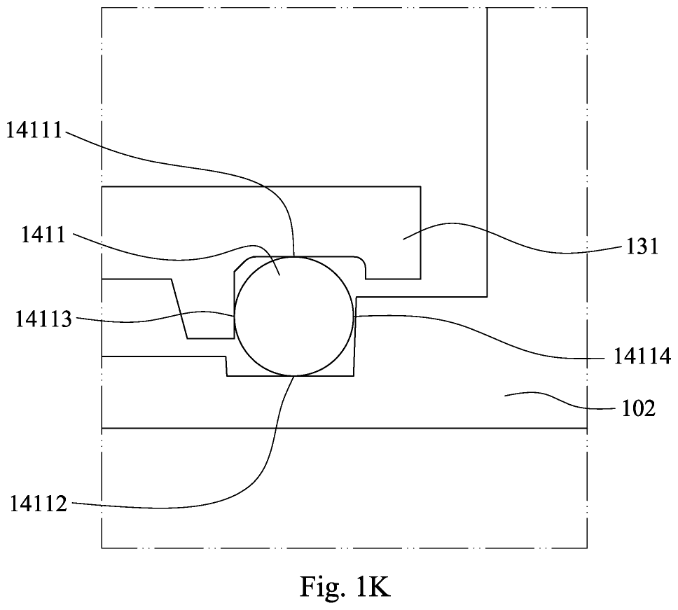

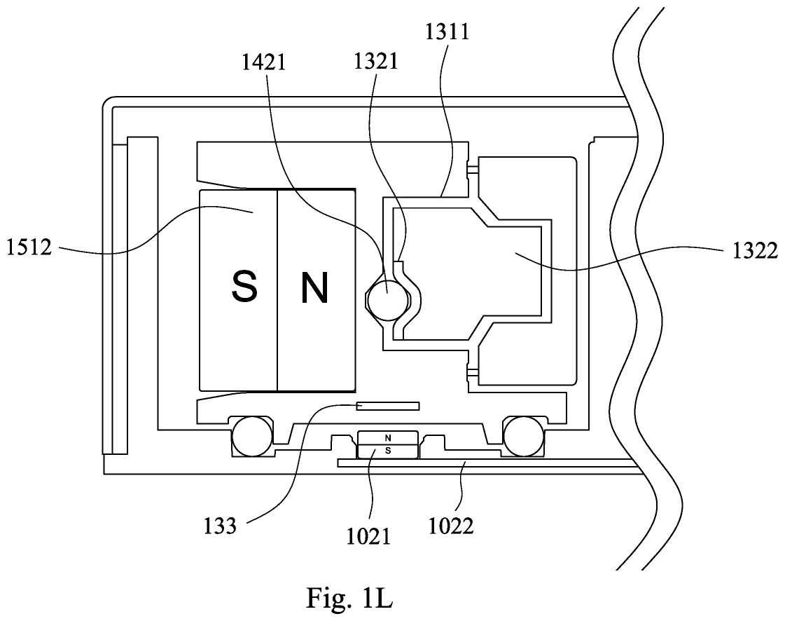

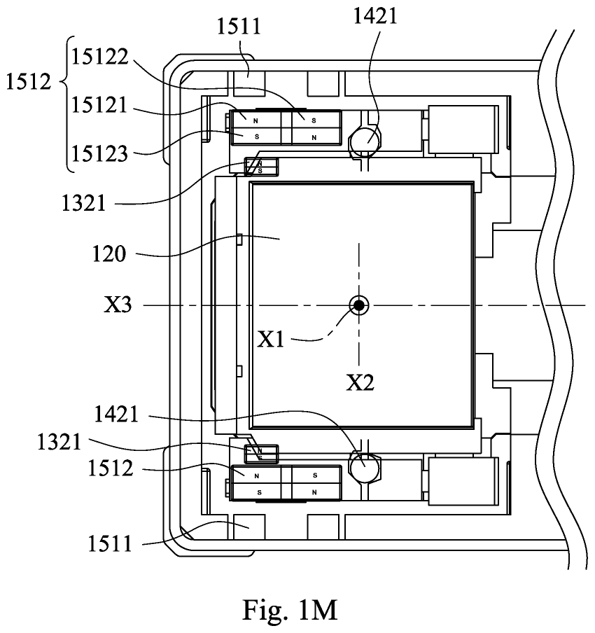

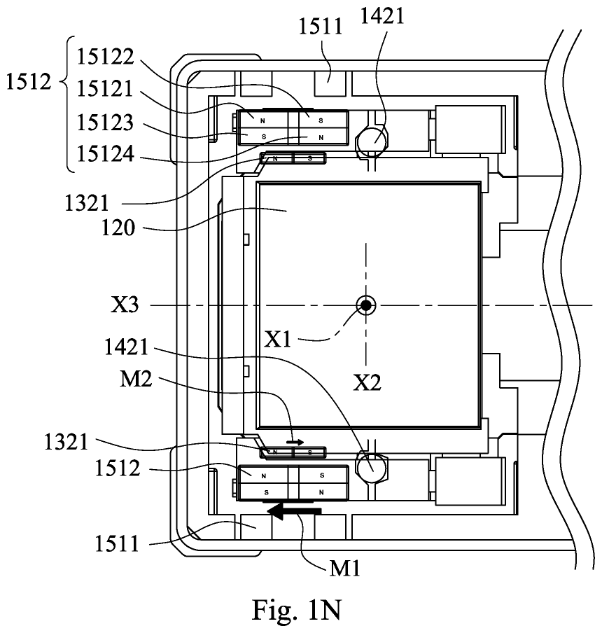

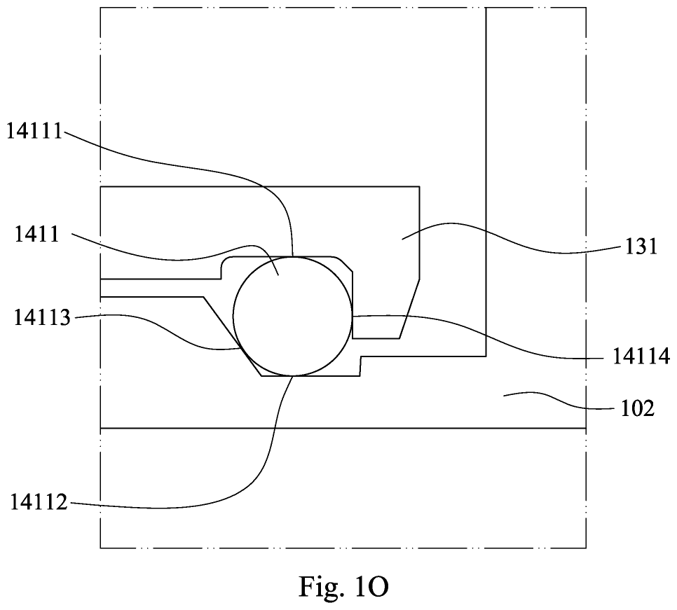

FIG. 1A is a three-dimensional schematic view of a camera module 100 according to the 1st embodiment of the present disclosure, FIG. 1B is a cross-sectional view of the camera module 100 according to the 1st embodiment of FIG. 1A, and FIG. 1C is an exploded view of the camera module 100 according to the 1st embodiment of FIG. 1A. As shown in FIG. 1A to FIG. 1C, the camera module 100 includes a case 101, an image lens assembly 110, a light path folding element 120, an image sensor 103 and a base 102, wherein the light path folding element 120, the image lens assembly 110 and the image sensor 103 are configured on the base 102, and the case 101 covers the base 102. The case 101 includes a light-passing hole 1011, the light path folding element 120 is disposed corresponding to the light-passing hole 1011, and the image lens assembly 110 is located on an image side of the light path folding element 120, wherein the image lens assembly 110 includes, along an object side to the image side, two lens groups, and the two lens groups are a first lens groups 111 and a second lens groups 112. A light L enters the camera module 100 via the light-passing hole 1011, the light path folding element 120 makes the light L from the first axis X1 being folded to a third axis X3, and then the light L passes through the image lens assembly 110 and then enters the image sensor 103.

The camera module 100 further includes a first carrier 131, a second carrier 132, a first rolling element assembly 141, a second rolling element assembly 142 (shown in FIG. 1F) and a third rolling element assembly 143. The first carrier 131 is connected to the base 102 via the first rolling element assembly 141, the second carrier 132 is connected to the first carrier 131 via the second rolling element assembly 142, and the light path folding element 120 is fixedly disposed on the second carrier 132. The image lens assembly 110 is connected to the base 102 via four third rolling elements 1431 of the third rolling element assembly 143.

Reference is made to FIG. 1D, FIG. 1E, FIG. 1F, FIG. 1G and FIG. 1H, wherein FIG. 1D is a schematic view of the first rolling element assembly 141 and a base magnet 1021 according to the 1st embodiment of FIG. 1C, FIG. 1E is a schematic view of the first carrier 131 according to the 1st embodiment of FIG. 1C which rotates by taking a first axis X1 as a rotation center, FIG. 1F is a schematic view of the second rolling element assembly 142, the first carrier 131 and the second carrier 132 according to the 1st embodiment of FIG. 1C, FIG. 1G is a schematic view of the first rolling element assembly 141, the first carrier 131 and the base 102 according to the 1st embodiment of FIG. 1C, and FIG. 1H is a schematic view of an attracting element 1321 according to the 1st embodiment of FIG. 1C.

As shown in FIG. 1D and FIG. 1E, the first rolling element assembly 141 is disposed on the base 102 and includes four first rolling elements 1411, wherein the first rolling elements 1411 are respectively equidistant from the first axis X1. A virtual circle V passes a center of each of the first rolling elements 1411, and the first axis X1 passes a center of the virtual circle V. The first carrier 131 is disposed on the base 102 via the first rolling element assembly 141, the first rolling element assembly 141 is disposed between the base 102 and the first carrier 131, and the first carrier 131 rotates by taking the first axis X1 as a rotation center.

The camera module 100 includes a first driver, the first drive includes two first driving magnets 1512 and two first driving coils 1511, and the two first driving magnets 1512 and the two first driving coils 1511 are located in pairs on two sides of the first carrier 131 and symmetrically disposed on an opposite side of the light path folding element 120 on the second axis X2. The two first driving magnets 1512 are fixedly disposed on the first carrier 131, and the two first driving coils 1511 are fixedly disposed on the base 102. The first driver drives the first carrier 131 to rotate by taking the first axis X1 as a rotation center. In specific, a first sensing element 1513 is disposed corresponding to one of the first driving magnets 1512, and the first sensing element 1513 is for sensing a change of magnetic field of the first driving magnet 1512.

FIG. 1I is an enlarged schematic view of a first driving magnet 1512, second rolling elements 1421, an attracting element 1321, a first magnetic guiding element 133, a base magnet 1021 and a second magnetic guiding element 1022 according to the first example of the 1st embodiment of FIG. 1C, and FIG. 1J is a plane schematic view of the first driving coil 1511, the first driving magnet 1512, the second rolling elements 1421 and the attracting element 1321 according to the first example of the 1st embodiment of FIG. 1C. As shown in FIG. 1F, FIG. 1H, FIG. 1I and FIG. 1J, the second rolling element assembly 142 is disposed on the first carrier 131, and the second carrier 132 is connected to the first carrier 131 via the second rolling element assembly 142. The second rolling element assembly 142 includes two second rolling elements 1421, and a second axis X2 passes a center of each of the second rolling elements 1421, wherein the second axis X2 is perpendicular to a first axis X1, and a third axis X3 is perpendicular to the second axis X2. The second carrier 132 rotates relative to the first carrier 131 by taking the second axis X2 as a rotation center. The second carrier 132 includes two attracting elements 1321, the two attracting elements 1321 are symmetrically disposed on an opposite side of the light path folding element 120 on the second axis X2 and disposed corresponding to the first driving magnet 1512 of the first driver. The attracting elements 1321 attract the first driving magnet 1512, so that the first carrier 131 and the second carrier 132 are contacted with the second rolling elements 1421 simultaneously. In specific, the second rolling elements 1421 can be accommodated in a plurality of slots (not shown) of the first carrier 131 or the second carrier 132, wherein the plurality slots can have different shapes so as to reduce the interference in the structure.

In specific, in the first example of the 1st embodiment, each of the attracting elements 1321 can be a magnet, but the present disclosure is not limited thereto. The attracting elements 1321 are disposed on the second carrier 132. The second carrier 132 can further include two assembling blocks 1322, wherein the assembling blocks 1322 protrude from the second axis X2 along a direction away from the light path folding element 120, and the attracting elements 1321 are disposed on the assembling blocks 1322. Further, the first carrier 131 includes an accommodating structure 1311 for accommodating the assembling blocks 1322, the second rolling element assembly 142 is disposed between the assembling blocks 1322 and the accommodating structure 1311, and the second rolling elements 1421 are disposed between the attracting elements 1321 and the first driving magnet 1512.

As shown in FIG. 1F and FIG. 1H, the camera module 100 can further include a second driver (not shown), the second driver includes a second driving coil 1521 and a second driving magnet 1522, and the second driving coil 1521 is disposed corresponding to the second driving magnet 1522 so as to drive the second carrier 132 to rotate by taking the second axis X2 as a rotation center. Further, the second driver can further include a second sensing element 1523, and the second sensing element 1523 is disposed corresponding to the second driving magnet 1522 so as to sense a change of magnetic field of the second driving magnet 1522.

As shown in FIG. 1J, the first driving magnet 1512 is shared by the first driving coil 1511 and the attracting element 1321, the first driving coil 1511 has a first magnetization direction M1 relative to the first driving magnet 1512, and the attracting element 1321 has a second magnetization direction M2 relative to the first driving magnet 1512, so that an attractive force is generated between the attracting element 1321 and the first driving magnet 1512, wherein the first magnetization direction M1 is parallel to the second magnetization direction M2.

The first driving magnet 1512 is a multi-pole magnet and includes a first magnetic pole 15121, a second magnetic pole 15122 and a third magnetic pole 15123. The first magnetic pole 15121 is disposed adjacent to the second magnetic pole 15122 and faces the first driving coil 1511, the third magnetic pole 15123 is disposed corresponding to the attracting element 1321, and the third magnetic pole 15123 is farther away from the first driving coil 1511 than the first magnetic pole 15121 and the second magnetic pole 15122. A direction from the first magnetic pole 15121 to the second magnetic pole 15122 is defined as the first magnetization direction M1.

As shown in FIG. 1G and FIG. 1I, the base 102 can further include a base magnet 1021, and the first axis X1 passes the base magnet 1021. The first carrier 131 can further include a first magnetic guiding element 133, and the first magnetic guiding element 133 is formed in the first carrier 131 by insert molding. The base magnet 1021 attracts the first magnetic guiding element 133, so that the first carrier 131 and the base 102 are contacted with the first rolling element assembly 141 simultaneously. Further, the first driving magnet 1512 is attracted on the first magnetic guiding element 133 so as to enhance the combination of the first driving magnet 1512 and the first carrier 131. Further, the base 102 can further include a second magnetic guiding element 1022, and the base magnet 1021 can be positioned on the base 102 by the second magnetic guiding element 1022. The second magnetic guiding element 1022 can further attract the magnet of the image lens assembly 110 so as to maintain the image lens assembly 110 on the base 102.

FIG. 1K is an enlarged schematic view of the first carrier 131, the first rolling element 1411 and the base 102 according to the first example of the 1st embodiment of FIG. 1C. As shown in FIG. 1D and FIG. 1K, on a cross section passing the first rolling element 1411 and the first axis X1 and being parallel to the first axis X1, the first rolling element 1411 includes an upper contact point 14111, a lower contact point 14112, an inner contact point 14113 and an external contact point 14114. The upper contact point 14111 is contacted with the first carrier 131. The lower contact point 14112 is contacted with the base 102. The inner contact point 14113 is closer to the first axis X1 than the upper contact point 14111 and the lower contact point 14112. The external contact point 14114 is farther away from the first axis X1 than the upper contact point 14111 and the lower contact point 14112. The inner contact point 14113 and the external contact point 14114 are not contacted with the first carrier 131 simultaneously. In FIG. 1K, only the inner contact point 14113 is contacted with the first carrier 131. A plane is defined by the lower contact point 14112 of each of the first rolling element 1411, and the plane is perpendicular to the first axis X1.

Furthermore, as shown in FIG. 1B and FIG. 1E, the light path folding element 120 includes a reflecting surface (reference number is omitted), and the reflecting surface is connected to the first axis X1 and a third axis X3. The first axis X1 and the second axis X2 intersect on the reflecting surface.

As shown in FIG. 1C simultaneously, the camera module 100 can further include a circuit board 104, wherein the first driving coil 1511 and the second driving coil 1521 can be fixedly disposed on the circuit board 104 in advance, and then the circuit board 104 is connected to the base 102, so that the first driving coil 1511 and the second driving coil 1521 can be fixedly disposed on the base 102, but the present disclosure is not limited thereto. Further, the image sensor 103 also can be fixedly disposed on the circuit board 104 in advance and then further connected to the base 102, and the image sensor 103 is disposed on an image side of the image lens assembly 110.

Further, as shown in FIG. 1F and FIG. 1H, the camera module 100 can further include two maintaining elements 160, the two maintaining elements 160 are respectively disposed on the assembling blocks 1322 of the second carrier 132 and then connected to the first carrier 131, and the two maintaining elements 160 can be served as buffering bodies when the first carrier 131 and the second carrier 132 are driven to rotate.

FIG. 1L is an enlarged schematic view of a first driving magnet 1512, second rolling elements 1421, an attracting element 1321, a first magnetic guiding element 133, a base magnet 1021 and a second magnetic guiding element 1022 according to the second example of the 1st embodiment of FIG. 1C. Comparing FIG. 1L with FIG. 1I, the main difference between the second example and the first example of the 1st embodiment of the present disclosure is that the attracting element 1321 of the second example is a metal element, e.g., iron that can be attracted by a magnet, and the attracting element 1321 is integrally formed on the assembling blocks 1322 of the second carrier 132 by insert molding.

The other structures and characteristics of the second example of the 1st embodiment can be the same as or similar with that of the first example of the 1st embodiment, so that the details thereof will not be described again herein.

FIG. 1M is a plane schematic view of a first driving coil 1511, a first driving magnet 1512, second rolling elements 1421 and an attracting element 1321 according to the third example of the 1st embodiment of FIG. 1C. Comparing FIG. 1M with FIG. 1J, the main difference between the third example and the first example of the 1st embodiment of the present disclosure is the arranging position of the attracting element 1321. In FIG. 1M, the first driving coil 1511 is farther away from the light path folding element 120 than the first driving magnet 1512, and the attracting element 1321 is closer to the light path folding element 120 than the first driving magnet 1512, so that it is favorable for reducing the interference of magnetic field between the first driving coil 1511 and the attracting element 1321. In specific, the first driving magnet 1512 is located between the first driving coil 1511 and the attracting element 1321, wherein the first magnetic pole 15121 of the first driving magnet 1512 is disposed adjacent to the second magnetic pole 15122 and faces the first driving coil 1511, the third magnetic pole 15123 is disposed corresponding to the attracting element 1321, and the third magnetic pole 15123 is farther way from the first driving coil 1511 than the first magnetic pole 15121 and the second magnetic pole 15122.

The other structures and characteristics of the third example of the 1st embodiment can be the same as or similar with that of the first example of the 1st embodiment, so that the details thereof will not be described again herein.

FIG. 1N is a plane schematic view of a first driving coil 1511, a first driving magnet 1512, second rolling elements 1421 and an attracting element 1321 according to the fourth example of the 1st embodiment of FIG. 1C. Comparing FIG. 1N with FIG. 1M, the main difference between the fourth example and the third example of the 1st embodiment of the present disclosure is the arranging position of the attracting elements 1321. As shown in FIG. 1N, the attracting element 1321 corresponds the third magnetic pole 15123 and the third magnetic pole 15124 of the first driving magnet 1512, a second magnetization direction M2 is defined between the attracting element 1321 and the first driving magnet 1512, and the second magnetization direction M2 is parallel and opposite to the first magnetization direction M1 defined between the first driving magnet 1512 and the first driving coil 1511.

The other structures and characteristics of the fourth example of the 1st embodiment can be the same as or similar with that of the first example of the 1st embodiment, so that the details thereof will not be described again herein.

FIG. 1O is an enlarged schematic view of a first carrier, 131 a first rolling element 1411 and a base 102 according to the fifth example of the 1st embodiment of FIG. 1C. Comparing FIG. 1O with FIG. 1K, the main difference between the fifth example and the first example of the 1st embodiment of the present disclosure is the relationship among the first rolling elements 1411, the first carrier 131 and the base 102. As shown in FIG. 1O, the inner contact point 14113 and the external contact point 14114 are not contacted with the first carrier 131 or the base 102 simultaneously. In specific, the inner contact point 14113 is contacted with the base 102 but not the first carrier 131, and the external contact point 14114 is contacted with the first carrier 131 but not the base 102.

The other structures and characteristics of the fifth example of the 1st embodiment can be the same as or similar with that of the first example of the 1st embodiment, so that the details thereof will not be described again herein.

### 2nd Embodiment

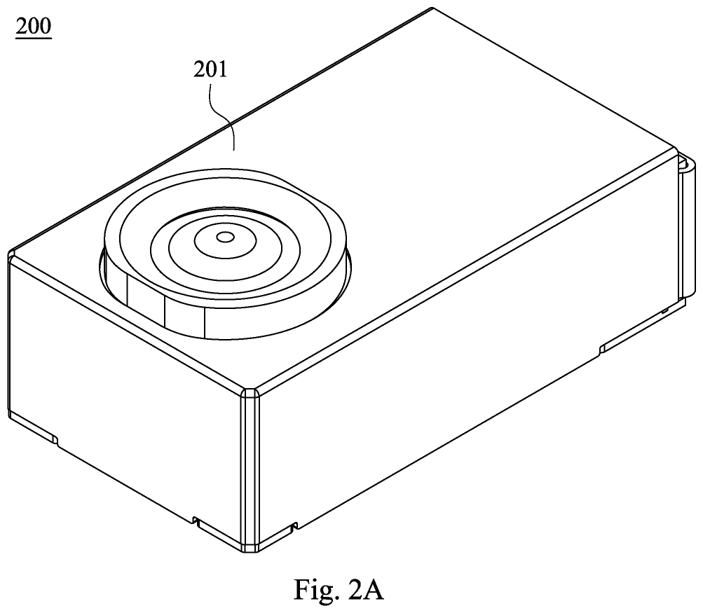

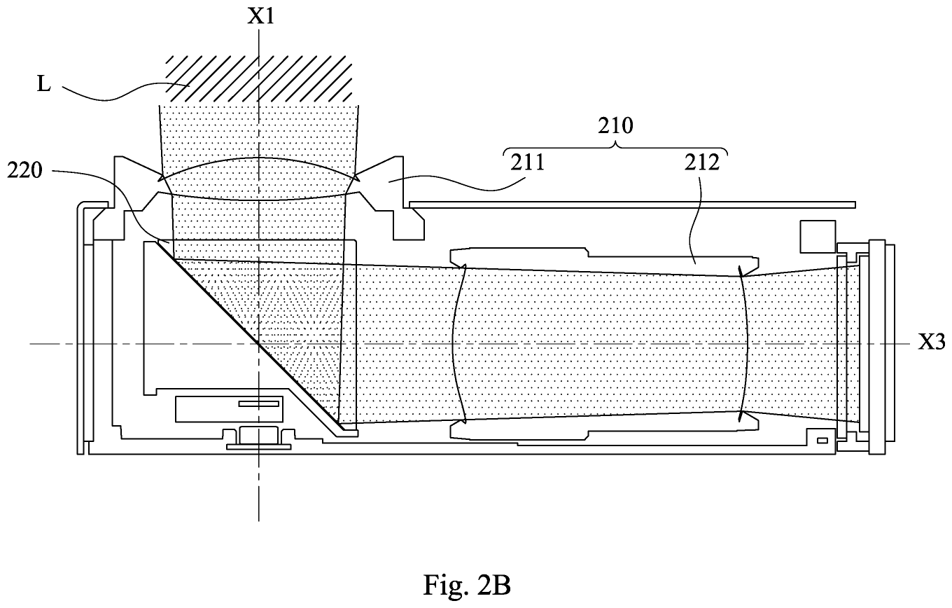

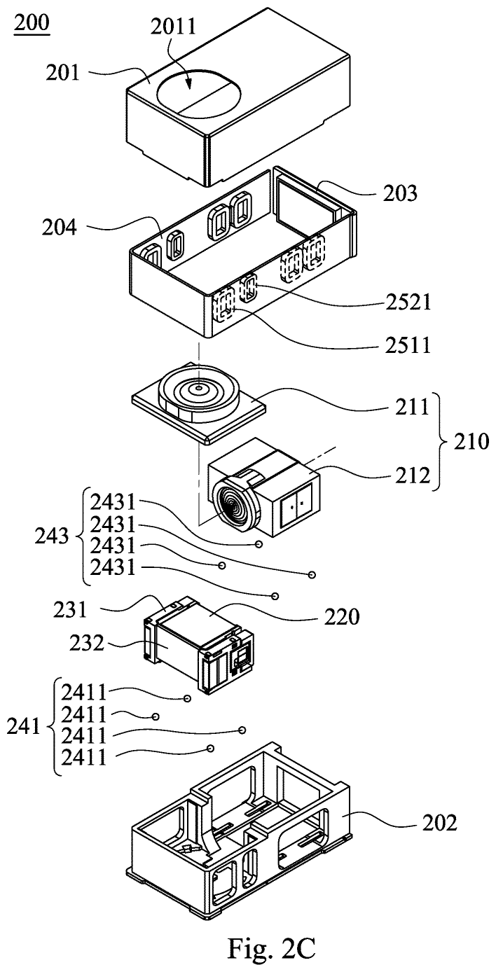

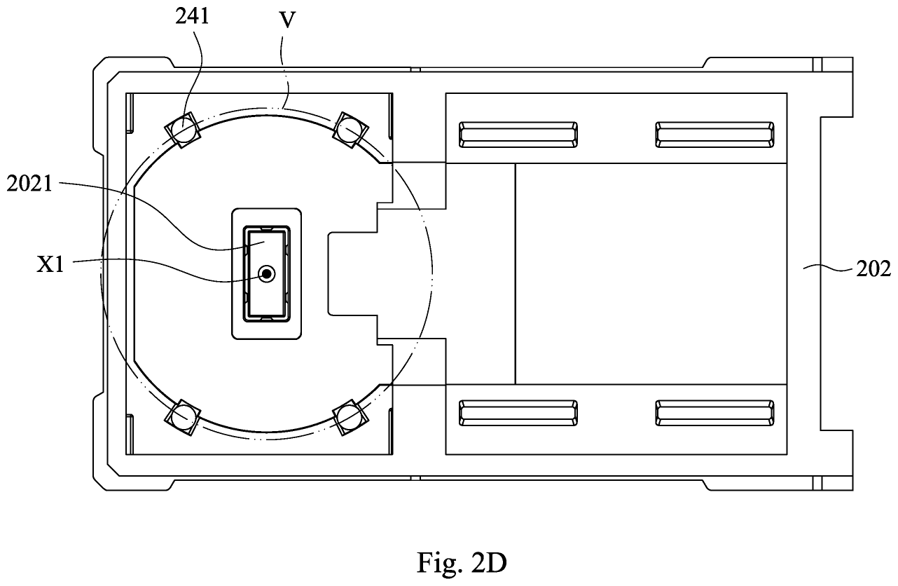

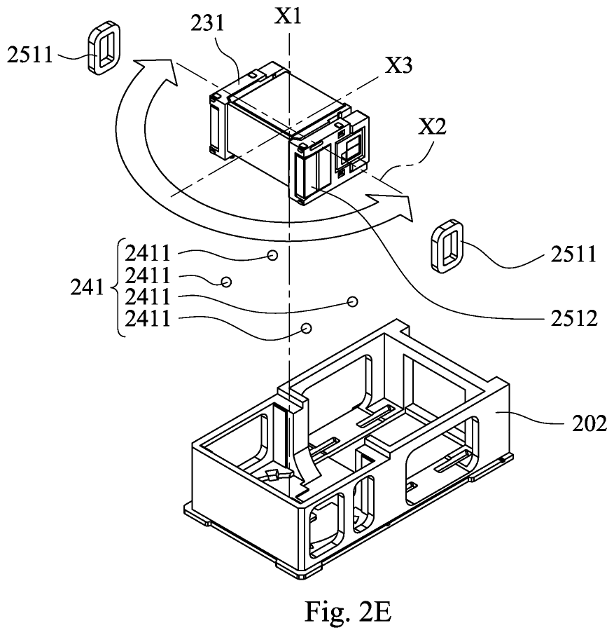

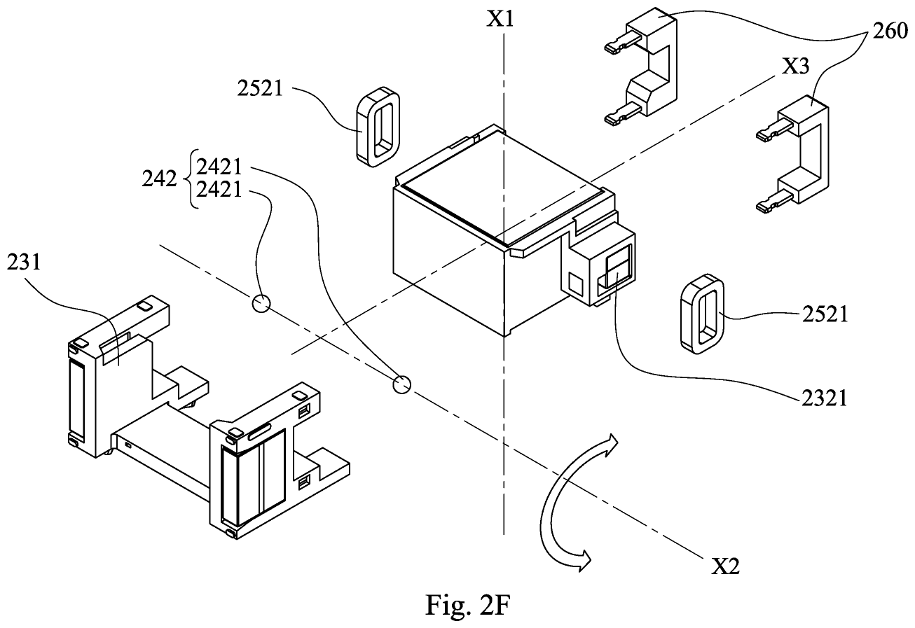

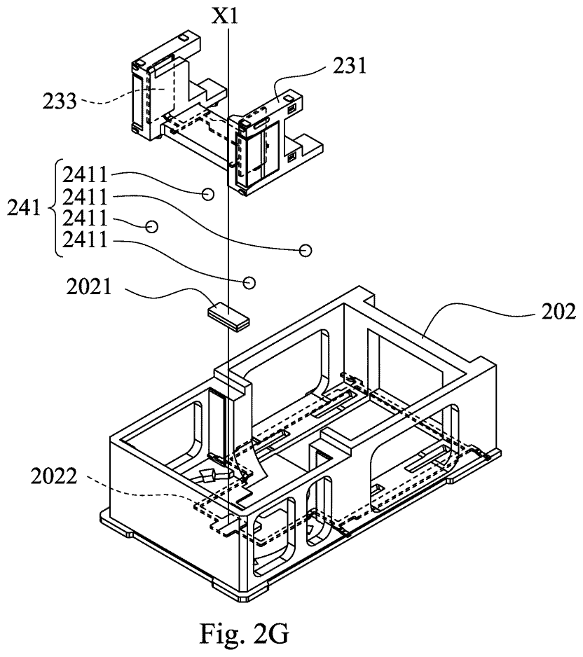

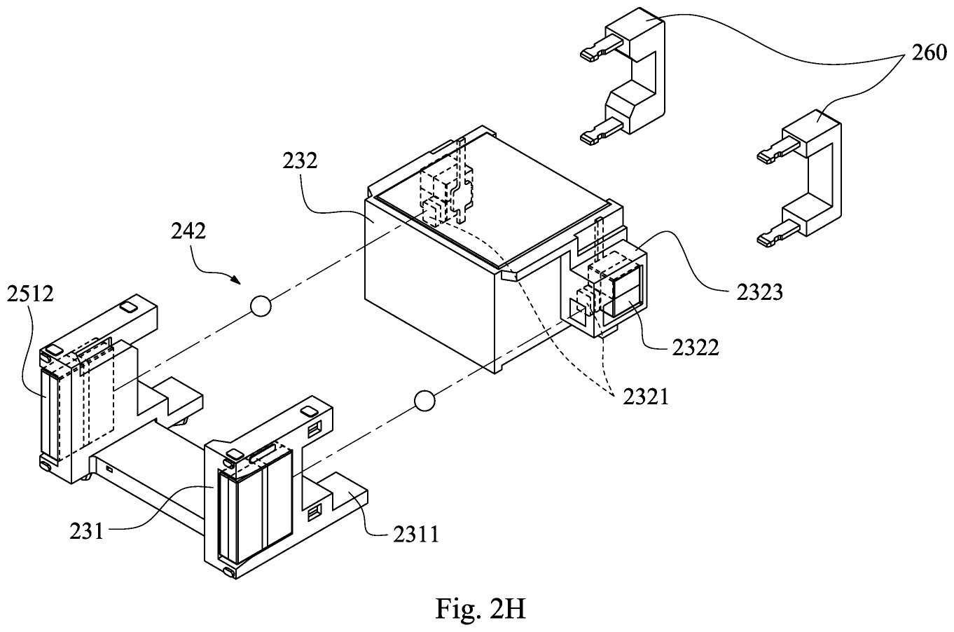

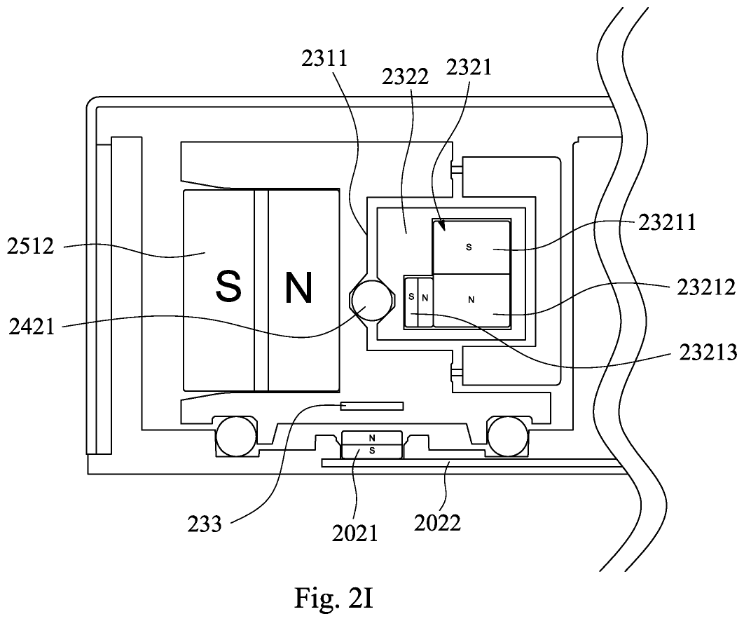

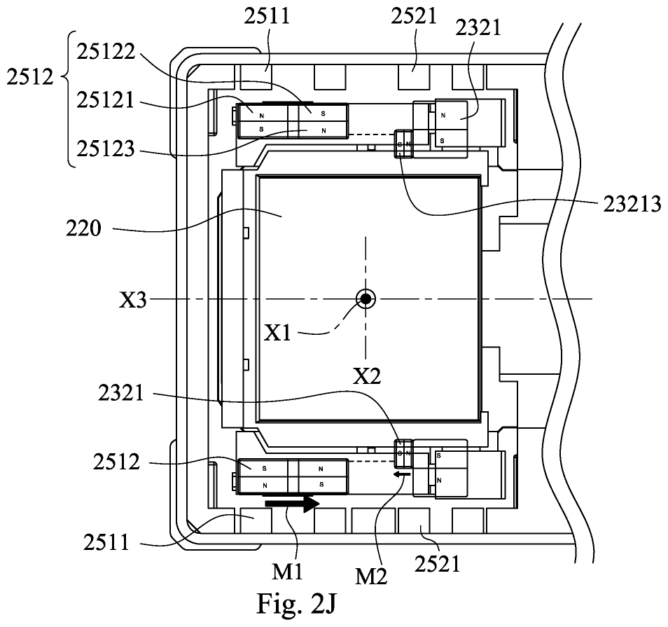

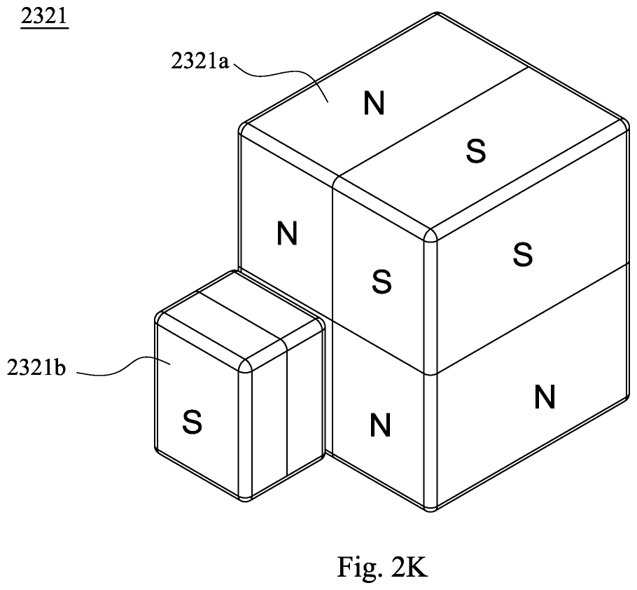

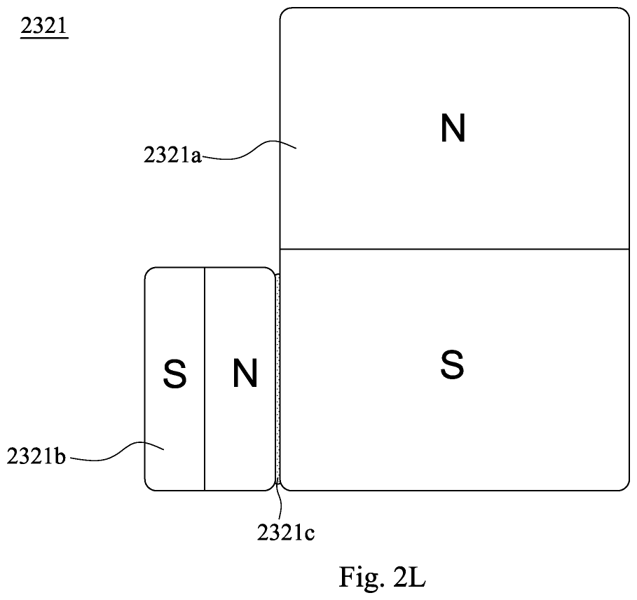

FIG. 2A is a three-dimensional schematic view of a camera module 200 according to the 2nd embodiment of the present disclosure second, FIG. 2B is a cross-sectional view of the camera module 200 according to the 2nd embodiment of FIG. 2A, and FIG. 2C is an exploded view of the camera module 200 according to the 2nd embodiment of FIG. 2A. As shown in FIG. 2A to FIG. 2C, the camera module 200 includes a case 201, an image lens assembly 210, a light path folding element 220, an image sensor 203 and a base 202, wherein the light path folding element 220, the image lens assembly 210 and the image sensor 203 are configured on the base 202, and the case 201 covers the base 202. The case 201 has a light-passing hole 2011. The image lens assembly 210 includes, along an object side to an image side, two lens groups, and the two lens groups are a first lens groups 211 and a second lens groups 212. A first axis X1 passes a center of the first lens group 211, the light path folding element 220 disposed on an image side of the first lens groups 211, and the light path folding element 220 makes a light from the first axis X1 being folded to a third axis X3 and then enters second lens group 212. The light L passes through the light-passing hole 2011 and then enters the camera module 200, and after the light L passing through the first lens group 211, the light path folding element 220 makes the light L from the first axis X1 being folded to the third axis X3, and the light L passes through the second lens group 212 and then enters the image sensor 203.

The camera module 200 further includes a first carrier 231, a second carrier 232, a first rolling element assembly 241, a second rolling element assembly 242 (shown in FIG. 2F) and a third rolling element assembly 243. The first carrier 231 is connected to the base 202 via the first rolling element assembly 241, the second carrier 232 is connected to the first carrier 231 via the second rolling element assembly 242, and the light path folding element 220 is fixedly disposed on the second carrier 232. The image lens assembly 210 is connected to the base 202 via four third rolling elements 2431 of the third rolling element assembly 243.

Reference is made to FIG. 2D, FIG. 2E, FIG. 2F, FIG. 2G and FIG. 2H, wherein FIG. 2D is a schematic view of the first rolling element assembly 241 and a base magnet 2021 according to the 2nd embodiment of FIG. 2C, FIG. 2E is a schematic view of the first carrier 231 according to the 2nd embodiment of FIG. 2C which rotates by taking a first axis X1 as a rotation center, FIG. 2F is a schematic view of the second rolling element assembly 242, the first carrier 231 and the second carrier 232 according to the 2nd embodiment of FIG. 2C, FIG. 2G is a schematic view of the first rolling element assembly 241, the first carrier 231 and the base 202 according to the 2nd embodiment of FIG. 2C, and FIG. 2H is a schematic view of an attracting element 2321 according to the 2nd embodiment of FIG. 2C.

As shown in FIG. 2D and FIG. 2E, the first rolling element assembly 241 is disposed on the base 202 and includes four first rolling elements 2411, wherein the first rolling elements 2411 are respectively equidistant from the first axis X1. A virtual circle V passes a center of each of the first rolling elements 2411, and the first axis X1 passes a canter of the virtual circle V. The first carrier 231 is connected to the base 202 via the first rolling element assembly 241, the first rolling element assembly 241 is disposed between the base 202 and the first carrier 231, and the first carrier 231 rotates by taking the first axis X1 as a rotation center.

The camera module 200 includes a first driver, the first driver includes two first driving magnets 2512 and two first driving coils 2511, and the two first driving magnets 2512 and the two first driving coils 2511 are located in pairs on two sides of the first carrier 231 and symmetrically disposed on an opposite side of the light path folding element 220 on the second axis X2. The first driving magnets 2512 are fixedly disposed on the first carrier 231, and the first driving coils 2511 are fixedly disposed on the base 202. The first driver drives the first carrier 231 to rotate by taking the first axis X1 as a rotation center.

As shown in FIG. 2F, the second rolling element assembly 242 is disposed on the first carrier 231, and the second carrier 232 is connected to the first carrier 231 via the second rolling element assembly 242. The second rolling element assembly 242 includes two second rolling elements 2421, and a second axis X2 passes a center of each of the second rolling elements 2421, wherein the second axis X2 is perpendicular to the first axis X1, and a third axis X3 is perpendicular to the second axis X2. The second carrier 232 rotates relative to the first carrier 231 by taking the second axis X2 as a rotation center.

FIG. 2I is an enlarged schematic view of a first driving magnet 2512, second rolling elements 2421, an attracting element 2321, a first magnetic guiding element 233, a base magnet 2021 and a second magnetic guiding element 2022 according to the first example of the 2nd embodiment of FIG. 2C, and FIG. 2J is a plane schematic view of a first driving coil 2511, the first driving magnet 2512, a second driving coil 2521 and the attracting element 2321 according to the first example of the 2nd embodiment of FIG. 2C.

The second carrier 232 includes two attracting elements 2321, and the attracting elements 2321 attract the first driving magnet 2512, so that the first carrier 231 and the second carrier 232 can be contacted with the second rolling elements 2421 simultaneously. Further, the camera module 200 can further include a second driver (reference number is omitted), and the second driver includes two second driving coils 2521. The two second driving coils 2521 are disposed respectively corresponding to the two attracting elements 2321 so as to drive the second carrier 232 to rotate by taking the second axis X2 as a rotation center.

In the 2nd embodiment, the second driver can be regarded as to be consisted of the second driving coils 2521 and the attracting elements 2321. Each of the attracting elements 2321 can be a multi-pole magnet and includes a fourth magnetic pole 23211, a fifth magnetic pole 23212 and a sixth magnetic pole 23213. The fourth magnetic pole 23211 is disposed adjacent to the fifth magnetic pole 23212 and faces the second driving coil 2521. The sixth magnetic pole 23213 and the first driving magnet 2512 are disposed corresponding to each other, and the sixth magnetic pole 23213 is farther away from the second driving coil 2521 than the fourth magnetic pole 23211 and the fifth magnetic pole 23212.

FIG. 2K is a three-dimensional schematic view of the attracting element 2321 according to the first example of the 2nd embodiment of FIG. 2C, and FIG. 2L is a plane schematic view of the attracting element 2321 according to the first example of the 2nd embodiment of FIG. 2C. As shown in FIG. 2K and FIG. 2L, the attracting element 2321 is a multi-pole magnet and includes a first magnetic pole magnet 2321a and a second magnetic pole magnet 2321b, so that it is favorable for driving the light path folding element 220 to rotate by the attracting element 2321. In the manufacturing process thereof, the second magnetic pole magnet 2321b is bounded to the first magnetic pole magnet 2321a by a glue 2321c, wherein the first magnetic pole magnet 2321a is a multi-pole magnet. It must be noted that the attracting element of the present disclosure can be arranged in different configurations according to actual requirements, or can be arranged by an integral multi-pole magnet so as to meet the needs, and the present disclosure is not limited thereto. The second carrier 232 can further include a third magnetic guiding element (not shown), and the third magnetic guiding element is formed in the second carrier 232 by insert molding. The attracting element 2321 can be positioned on the second carrier 232 by the third magnetic guiding element.

Further, the attracting elements 2321 are disposed on the second carrier 232. The second carrier 232 can further include two assembling blocks 2322, wherein the assembling blocks 2322 protrude from the second axis X2 along a direction away from the light path folding element 220, and the attracting elements 2321 are disposed on the assembling blocks 2322. Further, the first carrier 231 includes an accommodating structure 2311 for accommodating the assembling blocks 2322, the second rolling element assembly 242 is disposed between the assembling blocks 2322 and the accommodating structure 2311, and the second rolling elements 2421 are disposed between the attracting elements 2321 and the first driving magnet 2512.

Reference is made to FIG. 2J, the first driving magnet 2512 is a multi-pole magnet and includes a first magnetic pole 25121, a second magnetic pole 25122 and a third magnetic pole 25123. The first magnetic pole 25121 is disposed adjacent to the second magnetic pole 25122 and faces the first driving coil 2511, the third magnetic pole 25123 is disposed corresponding to the attracting element 2321, and the third magnetic pole 25123 is farther away from the first driving coil 2511 than the first magnetic pole 25121 and the second magnetic pole 25122. A direction from the first magnetic pole 25121 to the second magnetic pole 25122 is defined as a first magnetization direction M1.

In other words, the first driving magnet 2512 is shared by the first driving coil 2511 and the attracting element 2321, the first driving coil 2511 has the first magnetization direction M1 relative to the first driving magnet 2512, and the attracting element 2321 has a second magnetization direction M2 relative to the first driving magnet 2512, so that an attractive force can be generated between the attracting element 2321 and the first driving magnet 2512, and the first magnetization direction M1 is parallel to the second magnetization direction M2.

As shown in FIG. 2G and FIG. 2I, the base 202 can further include a base magnet 2021, and a first axis X1 passes the base magnet 2021. The first carrier 231 can further include a first magnetic guiding element 233, and the first magnetic guiding element 233 is formed in the first carrier 231 by insert molding. The base magnet 2021 attracts the first magnetic guiding element 233, so that the first carrier 231 and the base 202 are contacted with the first rolling element assembly 241 simultaneously. Further, the base 202 can further include a second magnetic guiding element 2022, and the base magnet 2021 can be positioned on the base 202 by the second magnetic guiding element 2022.

Furthermore, as shown in FIG. 2B and FIG. 2E, the light path folding element 220 includes a reflecting surface (reference number is not shown), and the reflecting surface is connected to the first axis X1 and a third axis X3. The first axis X1 and the second axis X2 intersect on the reflecting surface.

Reference is made to FIG. 2C, the camera module 200 can further include a circuit board 204, wherein the first driving coil 2511 and the second driving coil 2521 can be fixedly disposed on the circuit board 204 in advance, and then the circuit board 204 is connected to the base 202, so that the first driving coil 2511 and the second driving coil 2521 can be fixedly disposed on the base 202, but the present disclosure is not limited thereto. Further, the image sensor 203 also can be fixedly disposed on the circuit board 204 in advance and then further connected to the base 202, and the image sensor 203 is disposed on an image side of the image lens assembly 210.

Further, as shown in FIG. 2F and FIG. 2H, the camera module 200 can further include two maintaining elements 260, the two maintaining elements 260 are respectively disposed on the assembling blocks 2322 of the second carrier 232 and then connected to the first carrier 231, and the two maintaining elements 260 can be served as buffering bodies when the first carrier 231 and the second carrier 232 are driven to rotate.

### 3rd Embodiment

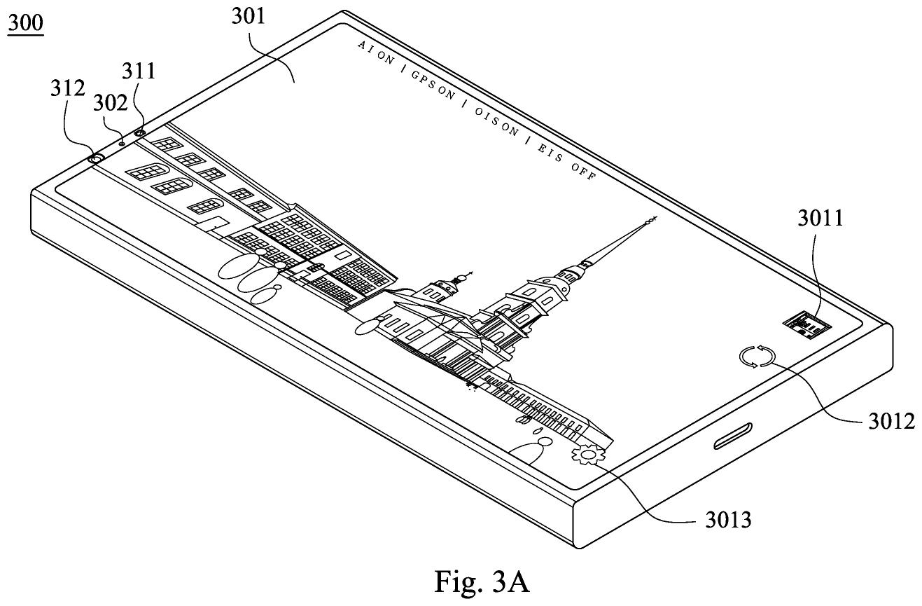

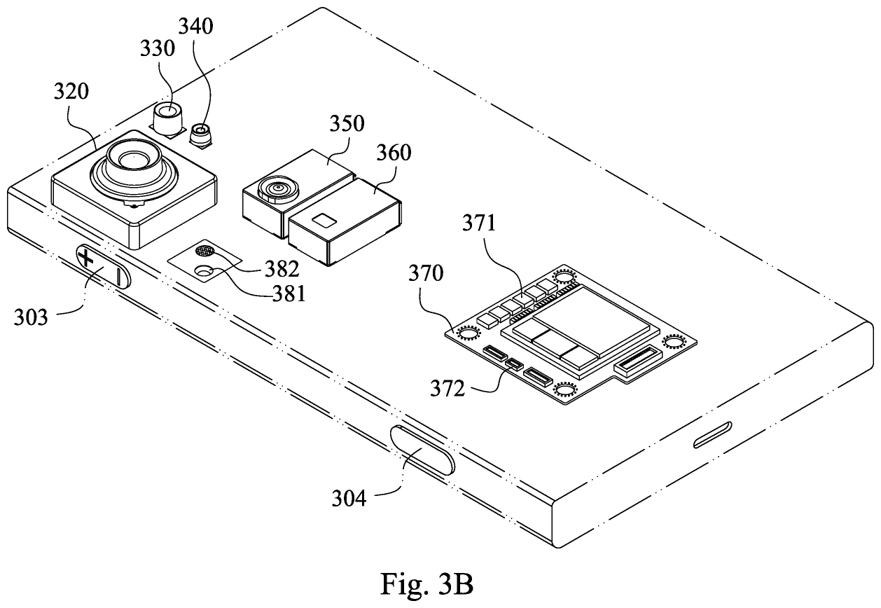

FIG. 3A is a schematic view of an electronic device 300 according to the 3rd embodiment of the present disclosure, and FIG. 3B is another schematic view of the electronic device 300 according to the 3rd embodiment of FIG. 3A. As shown in FIG. 3A and FIG. 3B, the electronic device 300 is a smart phone, and the electronic device 300 includes a plurality of camera modules and an imaging controlling interface 301. Furthermore, the camera modules are a front camera module 311, a TOF (Time-Of-Flight) module 312, a wide angle camera module 320, an ultra-wide angle camera module 330, a macro-image capturing camera module 340, a telephoto camera module 350 and a telephoto camera module 360, and the imaging controlling interface 301 can be a touch screen, but the present disclosure is not limited thereto. In specific, each of the camera modules can be any one of the aforementioned camera modules of the examples of the 1st embodiment to the 2nd embodiment, but the present disclosure is not limited thereto.

The front camera module 311 and the TOF module 312 can be arranged on the same side as the imaging controlling interface 301, a reminding light 302 can be disposed between the front camera module 311 and the TOF module 312, and the imaging controlling interface 301 can include an image replay button 3011, a camera module switching button 3012 and an integrated menu button 3013 according to actual needs, and it is favorable for switching and operating the camera modules and confirming the capturing results. Further, the electronic device 300 can further include a zoom controlling button 303 and a focus capturing button 304, wherein the zoom controlling button 303 and the focus capturing button 304 are arranged as the mechanical bottoms on the frame of the electronic device 300 so as to optimize the control of the user.

Further, the electronic device 300 can further include an electronic element board 370, wherein the electronic element 371, the connector 372 and other electronic elements can be disposed thereon according to the capturing needs. Further, the electronic element board 370 can be further equipped with a single chip system, wherein an image software processor, an image signal processor, a position locator, a transmit signal processor, a gyroscope, a storage unit and a random access memory can be integrated in the single chip system.

To enhance the image quality, the electronic device 300 can further include a flash module 381 and a focusing assisting element 382. The flash module 381 can be a flash lamp element, and the focusing assisting element 382 can be an infrared distance measurement element and a laser focus module, etc. Therefore, the camera module of the electronic device 300 equipped with an auto-focusing mechanism and the optical anti-shake mechanism can be enhanced to achieve the superior image quality. Further, the electronic device 300 of the present disclosure can have a capturing function with multiple modes, such as taking optimized selfies, high dynamic range (HDR) under a low light condition, 4K resolution recording, etc.

### 4th Embodiment

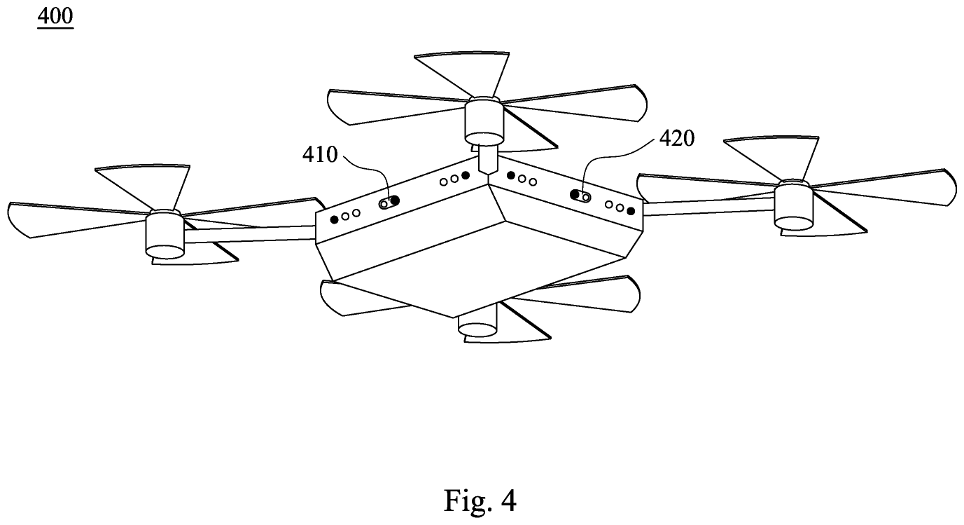

FIG. 4 is a schematic view of an electronic device 400 according to the 4th embodiment of the present disclosure. As shown in FIG. 4, the electronic device 400 is a drone camera including a side camera module 410 and a front camera module 420, wherein each of the camera modules can be any one of the aforementioned camera modules of the examples of the 1st embodiment to the 2nd embodiment, but the present disclosure is not limited thereto.

### 5th Embodiment

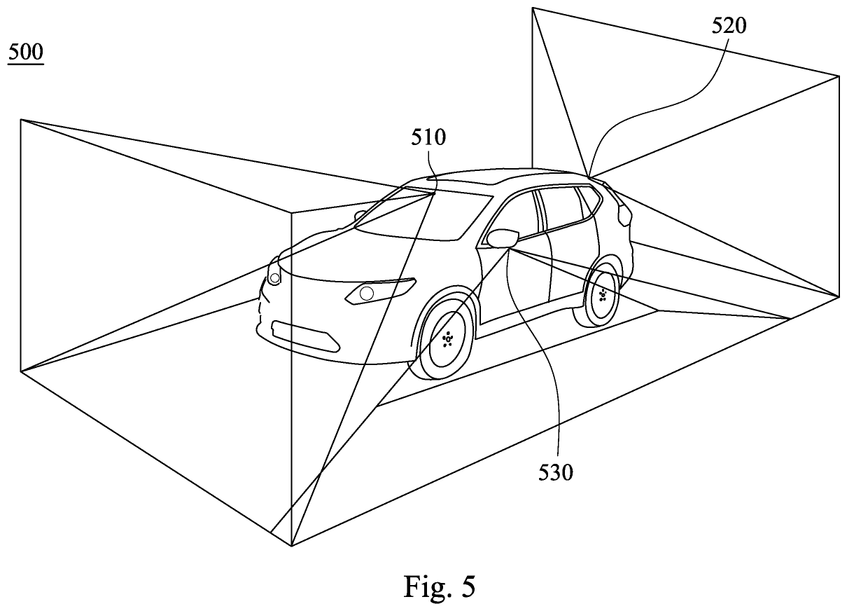

FIG. 5 is a schematic view of a vehicle instrument 500 of the 5th embodiment of the present disclosure. As shown in FIG. 5, the vehicle instrument 500 includes a front camera module 510, a back camera module 520 and a side camera module 530, wherein each of the camera modules can be any one of the aforementioned camera modules of the examples of the 1st embodiment to the 2nd embodiment, but the present disclosure is not limited thereto.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A camera module, comprising:
a base;
a first rolling element assembly disposed on the base and comprising:
at least three first rolling elements, wherein a virtual circle passes a center of each of the at least three first rolling elements, and a first axis passes a center of the virtual circle;
a first carrier connected to the base via the first rolling element assembly, the first rolling element assembly disposed between the base and the first carrier, and the first carrier rotating by taking the first axis as a rotation center;
a second rolling element assembly disposed on the first carrier and comprising:
at least two second rolling elements, wherein a second axis passes a center of each of the at least two second rolling elements, and the second axis is perpendicular to the first axis;
a second carrier connected to the first carrier via the second rolling element assembly, and the second carrier rotating relative to the first carrier by taking the second axis as a rotation center;
a light path folding element fixedly disposed on the second carrier, wherein the light path folding element makes a light from the first axis being folded to a third axis, and the third axis is perpendicular to the second axis; and
a first driver, comprising:
a first driving magnet fixedly disposed on the first carrier; and
a first driving coil fixedly disposed on the base, wherein the first driver drives the first carrier to rotate by taking the first axis as a rotation center;
wherein the second carrier comprises an attracting element, and the attracting element attracts the first driving magnet, so that the first carrier and the second carrier are contacted with the at least two second rolling elements simultaneously.

2. The camera module of claim 1, wherein the first driving magnet is a multi-pole magnet and comprises:
a first magnetic pole;
a second magnetic pole, wherein the first magnetic pole is disposed adjacent to the second magnetic pole and faces the first driving coil; and
a third magnetic pole disposed corresponding to the attracting element, wherein the third magnetic pole is farther away from the first driving coil than the first magnetic pole and the second magnetic pole.

3. The camera module of claim 1, wherein the first driving coil is farther away from the light path folding element than the first driving magnet, and the attracting element is closer to the light path folding element than the first driving magnet.

4. The camera module of claim 1, further comprising:
a second driver comprising a second driving coil, wherein the second driving coil and the attracting element are disposed corresponding to each other, and the second driver drives the second carrier to rotate by taking the second axis as a rotation center.

5. The camera module of claim 4, wherein the attracting element is a multi-pole magnet and comprises:
a fourth magnetic pole;
a fifth magnetic pole, wherein the fourth magnetic pole is disposed adjacent to the fifth magnetic pole and faces the second driving coil; and
a sixth magnetic pole disposed corresponding to the first driving magnet, wherein the sixth magnetic pole is farther away from the second driving coil than the fourth magnetic pole and the fifth magnetic pole.

6. The camera module of claim 1, wherein the first driving magnet comprises:
a first magnetic pole; and
a second magnetic pole, wherein the first magnetic pole is disposed adjacent to the second magnetic pole and faces the first driving coil, and a direction from the first magnetic pole to the second magnetic pole is defined as a first magnetization direction;
wherein the attracting element is a magnet and has a second magnetization direction, and an attractive force is generated between the attracting element and the first driving magnet;
wherein the first magnetization direction is parallel to the second magnetization direction.

7. The camera module of claim 1, wherein a number of the at least three first rolling elements is at least four, and the at least four first rolling elements are respectively equidistant from the first axis.

8. The camera module of claim 1, wherein,
the base further comprises a base magnet, and the first axis passes the base magnet; and
the first carrier comprises a first magnetic guiding element, and the first magnetic guiding element is formed in the first carrier by insert molding;
wherein the base magnet attracts the first magnetic guiding element, so that the first carrier and the base are contacted with the first rolling element assembly simultaneously.

9. The camera module of claim 1, wherein on a cross section passing one of the at least three first rolling elements and the first axis and being parallel to the first axis, the one of the at least three first rolling elements comprises:
an upper contact point contacted with the first carrier;
a lower contact point contacted with the base;
an inner contact point being closer to the first axis than the upper contact point and the lower contact point; and
an external contact point being farther away from the first axis than the upper contact point and the lower contact point;
wherein the inner contact point and the external contact point are not contacted with the first carrier or the base simultaneously.

10. The camera module of claim 9, wherein a plane is defined by the lower contact point of each of the at least three first rolling elements, and the plane is perpendicular to the first axis.

11. The camera module of claim 10, further comprising:
an image lens assembly comprising at least two lens groups;
wherein the first axis passes at least one of the at least two lens groups.

12. The camera module of claim 1, wherein the attracting element is integrally formed in the second carrier by insert molding.

13. The camera module of claim 1, wherein the first axis, the second axis and the third axis are perpendicular to each other.

14. The camera module of claim 1, wherein the light path folding element comprises a reflecting surface, and the reflecting surface is connected to the first axis and the third axis;
wherein the first axis and the second axis intersect on the reflecting surface.

15. The camera module of claim 1, wherein the at least two second rolling elements are disposed between the attracting element and the first driving magnet.

16. The camera module of claim 1, wherein,
the second carrier further comprises an assembling block, the assembling block protrudes from the second axis along a direction away from the light path folding element, and the attracting element is disposed on the assembling block; and
the first carrier comprises an accommodating structure for accommodating the assembling block, and the second rolling element assembly is disposed between the assembling block and the accommodating structure.

17. The camera module of claim 1, wherein,
the first driver is symmetrically disposed on an opposite side of the light path folding element on the second axis; and
the attracting element is symmetrically disposed on the opposite side of the light path folding element on the second axis, and the attracting element is disposed corresponding to the first driving magnet of the first driver.

18. An electronic device, comprising:
the camera module of claim 1, wherein the camera module comprises an image lens assembly and an image sensor, and the image sensor is disposed on an image side of the image lens assembly.

19. A camera module, comprising:
a lens group, wherein a first axis passes a center of the lens group;
a light path folding element disposed on an image side of the lens group, wherein the light path folding element makes a light from the first axis being folded to a third axis;
a base;
a first rolling element assembly disposed on the base and comprising:
at least three first rolling elements, wherein the at least three first rolling elements are respectively equidistant from the first axis;
a first carrier connected to the base via the first rolling element assembly, and the first carrier rotating by taking the first axis as a rotation center;
a second rolling element assembly disposed on the first carrier and comprising:
at least two second rolling elements, wherein a second axis passes a center of each of the at least two second rolling elements, the second axis is perpendicular to the first axis, and the second axis is perpendicular to the third axis;
a second carrier connected to the first carrier via the second rolling element assembly, wherein the second carrier rotates relative to the first carrier by taking the second axis as a rotation center, and the light path folding element is fixedly disposed on the second carrier; and
a first driver, comprising:
a first driving magnet fixedly disposed on the first carrier; and
a first driving coil fixedly disposed on the base, wherein the first driver drives the first carrier to rotate by taking the first axis as a rotation center;
wherein the second carrier comprises an attracting element, and the attracting element attracts the first driving magnet, so that the first carrier and the second carrier are contacted with the at least two second rolling elements simultaneously.

20. A camera module, comprising:
a lens group, wherein a third axis passes a center of the lens group;
a light path folding element disposed on an object side of the lens group, wherein the light path folding element makes a light from a first axis being folded to the third axis;
a base;
a first rolling element assembly, comprising:
at least three first rolling elements, wherein the at least three first rolling elements are respectively equidistant from the first axis;
a first carrier disposed on the base via the first rolling element assembly, and the first carrier rotating by taking the first axis as a rotation center;
a second rolling element assembly disposed on the first carrier and comprising:
at least two second rolling elements, wherein a second axis passes a center of each of the at least two second rolling elements, the second axis is perpendicular to the first axis, and the second axis is perpendicular to the third axis;
a second carrier disposed on the first carrier via the second rolling element assembly, wherein the second carrier rotates relative to the first carrier by taking the second axis as a rotation center, and the light path folding element is fixedly disposed on the second carrier; and
a first driver, comprising:
a first driving magnet fixedly disposed on the first carrier; and
a first driving coil fixedly disposed on the base, wherein the first driving coil drives the first carrier to rotate by taking the first axis as a rotation center;
wherein the second carrier comprises an attracting element, and the attracting element attracts the first driving magnet, so that the first carrier and the second carrier are contacted with the at least two second rolling elements simultaneously.
